(19) United States
(12) Patent Application Publication
(10) Pub. No.: US 2005/0027576 A1
(43) Pub. Date: Feb. 3, 2005

(54) Method and system for cooperative research and for compensation distribution

(76) Inventor: Matthew Klipstein, Encinitas, CA (US)

Correspondence Address: GORDON & REES LLP, 101 WEST BROADWAY, SUITE 1600, SAN DIEGO, CA, 92101, US

(21) Appl. No.: 10/631,287

(22) Filed: Jul. 31, 2003

(51) Int. Cl. G06F 17/60

(52) U.S. Cl. 705/8

(57) ABSTRACT

A method and system in which members are organized in a network in which intellectual property relating to an objective is identified, pooled and bundled so that a producer may exploit the solution, earn revenues and compensate the various members. The network preferably comprises a virtual private network through which members may contribute new knowledge and be updated by contributions of other members. The virtual private network also includes a system for recognizing revenue and assigning revenue to appropriate accounts such as cost centers and net income. The system credits various institutions in accordance with a system formula. Within each member, institutional revenue sharing policies and other agreements may be implemented.

### BACKGROUND OF THE INVENTION

The present invention relates to a system in which a number of entities use a network to cooperate in research to reach solutions and through which compensation is calculated for and allocated to members.

Research towards such objectives as medical breakthroughs, for example, is carried on in a generally competitive manner. Various entities worked to be the first to reach a certain objective. The objective may be a treatment for a particular form of cancer, practical production of a particular nanostructure or a system in accordance with a new communication standard. The performance of different entities is at least in part driven by that entity's traditional motivation. Individual researchers are motivated by peer recognition, corporations are motivated by profit and government and other institutional laboratories may be motivated by the desire for continued research funding. It is to be expected that entities will behave in a manner that has fostered their survival and their growth.

Different forms of coorporation and communication exist among the competing entities. One manner in which knowledge is shared is through journal publications. While journal publications provide an important contribution and seek to establish validity of what they are publishing, they do not provide, nor are they intended to provide, a vehicle for the most timely update of status research in a particular area. In an editorial entitled “Tracking the Peer-Review Process,” N. Eng. Journal Med., Volume 343: 1485-1486, Nov. 16, 2000, a peer-review process for a well-respected, reliable journal is explained. Manuscripts received by the journal are sent to editors who review submissions as to whether they are appropriate for consideration for publication and that particular journal. The manuscript may be sent to a second editor. At that stage, the manuscript is sent to two outside reviewers for evaluation as to scientific validity and other measures of worthiness. After the reviews are returned, an editor assesses the manuscript along with the comments. Opinions of other reviewers or the editorial staff may also be sought. At that point, the manuscript is often returned with an invitation for the authors to revise it and respond to certain questions. After that process is completed, the paper may be accepted for publication. While reliability is maintained by this process, a time lag is necessarily introduced into the publication process.

Another form of cooperation is through presentations at meetings of professional societies. Such meetings often have calls for papers. Attendance at such meetings may require a significant commitment of resources for travel and lodging. The number of papers in a particular, specific subject area may of necessity be small. The attendee may pay a high cost for a limited update in a particular area.

Formal cooperation between institutions normally is conducted on the basis of high level communications. While particular researchers may wish to share information, inter-institutional communications may go through the ranks of department head, vice chancellor, chancellor, president or regents. Another form of research funding is described in NIH Grants Policies Statement (Rev 03/01), United States Department of Health and Human Services, March 2001. Researchers write grant applications for funding. The researchers are influenced by their particular research objectives and areas in which funding opportunities exist. While this process serves an important objective and encouraging research, it does not serve the objective of encouraging cooperation between different institutions.

These varying vehicles for cooperation must, of necessity, have a limited objective. If cooperation is too great, an institution risks losing its proprietary position, and the advantages that proprietary position infers over other institutions in the quest to seek rewards. Institutions will generally not wish to make disclosures that will result in their losing the ability to seek patent protection on innovations. Traditional systems do not provide a mechanism for maximizing cooperation between the types of entities that perform research toward a particular and while preventing complete loss of rewards due to having a proprietary position.

Traditional research arrangements tend to engender ambivalent attitudes towards cooperation relating to fear and greed. There is a fear that a competing researcher will be beaten to a revenue-bearing solution be another and not be able to capitalize on significant expenditures of funds and human capital. The “losing” researcher may be shut out of participation in a new market. The greed factor motivates a party to try to earn all available revenue without the need to share with other parties. Game theory has been applied to management science, but has not been brought to bear on the specific issue of solving a particular research objective.

A work widely regarded as the source of game theory application to business endeavors is John von Neumann and Oskar Morgenstern, Theory of Games and Economic Behavior; Princeton N.J.; Princeton University Press, 1944; 3^{rd} ed. New York, Wiley, 1953. John F. Nash, “Equilibrium points in n-person games”, 48-49, Proceedings of the National Academy of Sciences, 36, 1950 and John F. Nash, Non-Cooperative Games, 286-295, Annals of Mathematics 54, 1951 established the “Nash Equilibrium.” This is a concept in game theory to define a kind of optimum game strategy for games where no such optimum was previously defined. It there is a set of strategies for a game with the property that no player can benefit by changing his strategy while the other players keep their strategies unchanged, then that set of strategies and the payoffs resulting therefrom constitute a Nash equilibrium. More recently, game theory has addressed the concept of competing for “a share of the pie” that involves cooperation as well as competition in Adam M. Brandenburger and Barry J. Nalebuff, Co-Opetition: A Revolutionary Mindset That Combines Competition and Co-Operation: The Game Theory Strategy That's Changing the Game of Business; New York, Doubleday; 1996. It is desirable to find a method to encourage solution of significant research problems.

### SUMMARY OF THE INVENTION

The present invention employs a relationship called the Klipstein Equilibrium in which strategies of a number of players with respect to each other is fixed. A degree of balancing is provided between the centrifugal force of greed and the centripetal force of fear. Members are constrained to pursue a strategy that will yield a payoff for all members of the system. The system influences members to tend to find efficiencies inherent in a self-organizing system.

It is a particular advantage of the present invention to provide a system in which equilibrium is established that will encourage cooperation among researchers, physicians, pharmaceutical companies, and philanthropists by tracking by whom and when every invention/discovery is made and by sharing the proceeds therefrom between the inventor/discoverer and all other participants.

It is a further particular advantage of the present invention to provide a system of the type described in which “side deals” as between a philanthropist and a particular researcher, are encouraged.

It is also a particular invention of the present invention to provide a method and system in which speed of solution of a particular problem is facilitated by establishing a system permitting members in the system to share information and resources in order to achieve a common goal while providing for recognition of revenue and assignment of revenue to member accounts in accordance with functioning of the system.

Briefly stated, in accordance with the present invention, there are provided a method and system in which members are organized in a system in which intellectual property relating to an objective is identified, pooled and bundled so that a partner, e.g. a licensee, may exploit the solution, earn revenues and compensate the members of the system. The network comprises a framework linking member, e.g. a virtual private network (VPN). Members contribute new knowledge and are updated by contributions of other members. The VPN tracks by whom and when every invention/discovery is submitted and by whom and when every proposed addition/revision is made. The VPN also tracks threaded discussions among the members, thus creating a record of who has contributed what to each ultimate invention. Revenue from each discovery/invention is divided between the inventor/discoverer and the rest of the members according to a rule, e.g. 50% to the inventor/discoverer and 50% to the other members. Thus all members have an incentive to see the system succeed.

Further rules may be instituted to foster success of the system. For example, to prevent “freeloading” or non-cooperation, members may be removed from the system by a vote of unanimous less one. New members are added by a vote of unanimous less one. Members are thus encouraged to share their knowledge and ideas by virtue of a mechanism that allows any members who are removed or who join after the commencement of a project are compensated according to a further rule. The rule may be administered made by a rule-enforcing mechanism such as a Technology Oversight Board in each case.

### BRIEF DESCRIPTION OF THE DRAWINGS

The invention is further described by reference to the following description taken in connection with the following drawings.

Of the drawings:

FIG. 1 is an illustration is a system operating in accordance with the present invention;

FIG. 2 is a flow diagram illustrating registration of information in the system;

FIG. 3 is a flow diagram illustrating interactive use of information contained in the system;

FIG. 4 is a flow diagram illustrating a virtual meeting among members in the system;

FIG. 5 is a block diagram illustrating a subsystem in which a subset of members, for example, two members, engage in an additional interaction within the context of the system;

FIG. 6 is an illustration of a subsystem operated by a “lead institution”; and

FIGS. 7, 8 and 9 are illustrations demonstrating the recognition of revenue and assignment of revenue to accounts of members.

### DETAILED DESCRIPTION

The present invention comprehends the production of tangible results in a context where a plurality of parties work to reach one goal or similar, consistent or complementary goals. Reaching these goals may include providing solutions that will compete with each other, whether in commercial or academic terms. A solution is any exploitable result. An example of a common goal is a cure for Parkinson's Disease. Of course, there will not be such a thing as “a cure” or “the cure.” Differing treatments may have varying levels of efficacy. They may address different forms of the disease. Alternatively, research may lead to a diagnostic technique. Research can also produce exploitable products such as software and books. Any of these items may comprise a “solution.” Since the solution may be revenue bearing, it may also be referred to as a “winning solution.”

A highly effective research effort may require many types of potential participants. These will foreseeably include universities, pharmaceutical companies, biotech companies, researchers, charitable foundations and others to share information and resources in order to achieve a solution or solutions. The Klipstein Equilibrium recognizes that these entities may have differing motivations. Peer recognition may be most significant to an individual researcher, continued research funding is essential to many university laboratories and profit is the traditional motivator for commercial entities. The Klipstein Equilibrium also recognizes that these motivations are not likely to change and that the entities and individuals wish to continue to behave in a manner that they perceive as being in their self-interest. There is a natural tension between centrifugal and centripetal forces greed and fear. This may be expressed as, “Why should I share with others when I believe I will win the race to a cure?” versus “A coalition where I am guaranteed some of the financial reward makes sense, since I have no guarantee I will win the race.”

The Equilibrium further postulates that many individuals and entities acting in accordance with their own micromotives will organize into a beneficial macrobehavior more efficiently if left to their own devices within broad rules described below than any top-down organization to which they might willingly submit. Self-organization is the essence of the Equilibrium. Participants join in a consortium. The impetus to join the consortium comes from a revenue sharing formula such that a “winning” player,” an “inventor” of a “winning solution,” receives a “winner's share” of the amount of revenue accruing from the winning solution in addition. “Inventor” should be defined by the consortium. “Inventor” as defined by Title 35 of the United States Code is one suitable definition. The producer of the winning solution is designated a “winner.” The winning solution is on for which a participant will pay. The “winner” is based on the correspondence of data input to the network with the winning solution. If members set up appropriate criteria, more than one member would comprise a winner.

Each “losing” player, i.e. a participant who did not produce the winning solution, still is designated as a participant and receives a “participant's share.” These percentage shares are selectable according to negotiation when the Consortium is founded. This, formula is intended to account for the amount of help the “Inventor” has received, presumably from the other participants in the consortium contributing in some way. Also, side-deals are not only permitted, but encouraged. Anyone with a deal with a winning player will share in the winner's share according to their private agreement. Of course, the designations “winner” and “participant” are arbitrary, and other terminology may be used to designate members in the capacities.

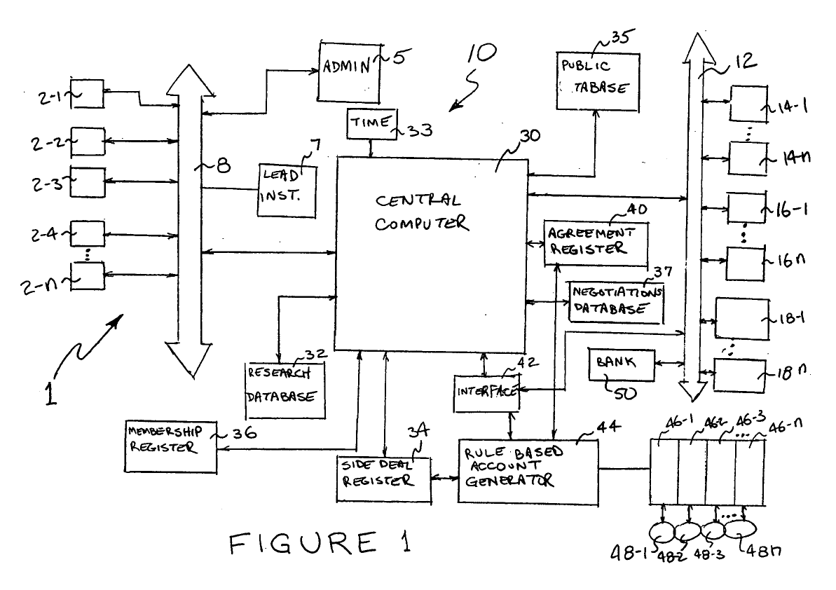

FIG. 1 illustrates a system according to the present invention utilized by a consortium 1 having members 2. Any number of members 2 may be included in the consortium 1. They are denoted in FIG. 1 as 2-1, 2-2, 2-3, 24, . . . , 2-n. Collectively, they are referred to as members 2. The members 2 may utilize an administrator 5 to facilitate operation within consortium rules. Members 2 and an administrator 5 may communicate via a bus 8 with through a network 10. In addition to the administrator 5, or the alternative, the consortium 1 may comprise a lead institution 7. The lead institution 7 may handle interface functions for the consortium 1. Such a function could include communicating with parties 16 (see below) with whom the consortium 1 is seeking to make deals or parties 18 (see below) with whom the consortium has made deals.

The members 2 are participants in an agreement constrained by the Klipstein Equilibrium in which a winning solution or winning solutions have been defined and in which a revenue sharing rule has been established. A specific example of a revenue sharing rule is discussed below in connection with the rule based account generator 44.

The bus 8 represents well-known communications interconnections. The bus 8 may comprise any and all of local area networks, wide area networks, the Internet, wireless or telephone connections or other means for interconnecting individual members. The network 10, in accordance with the current state of the art, will most conveniently comprise a virtual private network. Once again, other known means of interconnecting members 2 may be provided. Members 2 may comprise many different types of entities. These entities may include large corporate research departments, small research companies, university technology transfer offices, university academic departments, university-based institutes, and various governmental agencies, e.g. units of city, state, or federal domestic or foreign governments. The invention is particularly suited to medical research in that a wider variety of members as described above having a concomitant wider variety of motivations will normally be utilized than in the conventional industrial joint venture, the traditional university-industry agreement or the conventional industry-government, cooperative research and development agreement.

The network 10 communicates via a bus 12 to various populations outside of the consortium 1. Public parties 14, denoted in FIG. 1 as 14-1, . . . , 14-n, may constitute the world at large. Public parties 14 are granted access to a limited range of information that the consortium 1 has designated to be freely available in the public domain. Another group of entities 16, denoted in FIG. 1 as entities 16-1, . . . , 16-n, may comprise entities negotiating to establish arrangements with the consortium 1. The negotiating entities 16 are granted privileges to see a separate range of information. The range of access of an individual entity 16 will depend on privileges granted by the consortium 1 in accordance with need to know, level of proprietary obligations undertaken and the subject matter interest of the entity 16. Additionally, partners 18, designated in FIG. 1 as partners 18-1, . . . , 18-n constitute parties that have contracts with the consortium 1 such as licenses and manufacturing rights. It should be noted that the bus 12 need not constitute a separate bus from the bus 8. The bus 12 is separately illustrated for the sake of description of the present embodiment.

The network 10 includes a central computer 30 including known architectures for storing data, processing data, processing authorizations of members 2, the public 14 and any other party communicating with the central computer 30. A number of subunits of the central computer 30 are next described. The subunits need not comprise discrete components. Separate databases in the illustration of FIG. 1 may, in fact, comprise portions of a single database or memory sections within the central computer 30. Various memories may comprise discrete memories, dedicated sections of a single memory or may comprise individual locations intermingled among individual locations indicative of data being illustrated as being in other memories. A research database 32 stores submissions from members 2. A clock circuit 33 detects submissions from members 2 and “time stamps” them by writing a date and a time of receipt onto each stored document. While the ultimate purpose of the consortium 1 is to produce successful solutions so that the consortium 1 may make deals with partners 18, various members 2 may make deals among themselves. These deals are referred to as side deals. Data indicative of side deals is stored in a side deal register 34. The side deal register 34 may also store records of negotiation in progress. Records may be password protected so that only parties to the negotiations have access to records of a particular negotiation. Publicly available data is stored in a public database 35.

The network 10 further comprises a membership register 36. Members 2 may vote to admit other members and/or to remove members. Votes of members 2 are tallied in the membership register 36. In one form, the result in register 36 will result corresponding to an invitation for potential member receiving a vote of at least N−1 where N is the number of current members 2. This requirement for membership will prevent a single member 2 from “blackballing” a prospective member. The membership register 36 in one form will register a result equivalent expulsion of a member in response to a vote of not less than N−1 where N is the total number of current members. This requirement for a vote prevents collusion of a member worthy of expulsion with a single member to prevent the expulsion.

A negotiations database register 37, whose records may be password protected, is provided to store negotiations between negotiation entities 16 and members 2. Agreements are kept in an agreement register 40. A partner 18 who has completed an agreement with the consortium 1 and is participating in performance of the agreement may communicate via the bus 12 to an interface 42. Communications to the interface 42 may include sales and royalty reports as well as electronic funds transmittals. A rule based account generator 44 monitors data received via the interface 42, particularly fund transmittals. The rule based generator 44 produces an accounting for transactions register 46 having locations 46-1, 46-2, 46-3 . . . 46-n. The transactions register 46 may have one section for each member 2. Further accounts may be maintained reflecting overall accounts for the consortium 1, separate before and after tax accounts for those member 2 are subject to taxation. The transactions register 46 may update balances in an account register 48 having locations 48-1, . . . , 48-n for each member 2 or any other entity that might be defined within the terms of the consortium 1. The account register 48 registers funds received and due to a member 2 or other entity. The disbursements register 48 may further execute payments via the interface 42 through interface with a bank 50. The bank 50 may make disbursements to the transaction register 46 and the account register 48.

A rule agreed to by the members 2 of the consortium 1 for sharing of compensation to the consortium 1 may be stored in the rule based account generator 44 to produce results indicative of compensation due to members 2. In the preferred form, one member 2 is a “winning” player,” i.e., an “inventor” of a “winning solution.” The winning member 2 receives a “winner's share” of the amount of revenue accruing from the winning solution. Each “losing” player, i.e. a member 2 who did not produce the winning solution, still receives a “participant's share.” These percentage shares are selectable according to negotiation when the Consortium is founded. In one form, the rule defining these shares is:
Rw=(100%−(N−1%))×I where Rw is the result defining the winner's share, N is the total number of participants, i.e. members 2, in the consortium 1, and I is the amount of income accruing from the research solution; and
Rp=I/(N−1), where Rp is the result equal to the participant's share, and wherein N does not exceed 51. In this example, if there are 31 members 2 and the winning solution yields $20,000,000, the winner receives 70% of $20,000,000. The winner's share is $14,000,000. The other members 2 share $6,000,000. Therefore, the participant's share is $200,000. If there are 7 players and the discovery yields $20,000,000, the winner receives 94% of $20,000,000, or $18,800,000. The participant's is $1,200,000 divided six ways, or $200,000. These examples are aggregate payments. In practice, income I will accrue periodically and be shared by the members 2 periodically.

An amount due to a participant due is adjusted in accordance with any side deals to which the member 2 may be a party. The side deal register 34 is illustrated as being coupled to the rule based account register 44 to illustrate this adjustment. Many well-known different forms of physical connections may be made to provide this result.

FIGS. 2, 3 and 4 illustrate different processes performed by the consortium 1. FIG. 2 illustrates entry of data by a source member 2 in the research database 32. At block 100, a member 2 gains access to the network 10 by entering an access code which is recognized by the central computer 30. At block 102, the member 2 uploads data to the network 10. The register unit 34 provides a “timestamp” on the upload entry at block 104 and, at block 106, data is supplied to the research database 32. Data is used in the generic sense to indicate a signal input. The uploaded data could comprise research, comments, administrative correspondence or other communications.

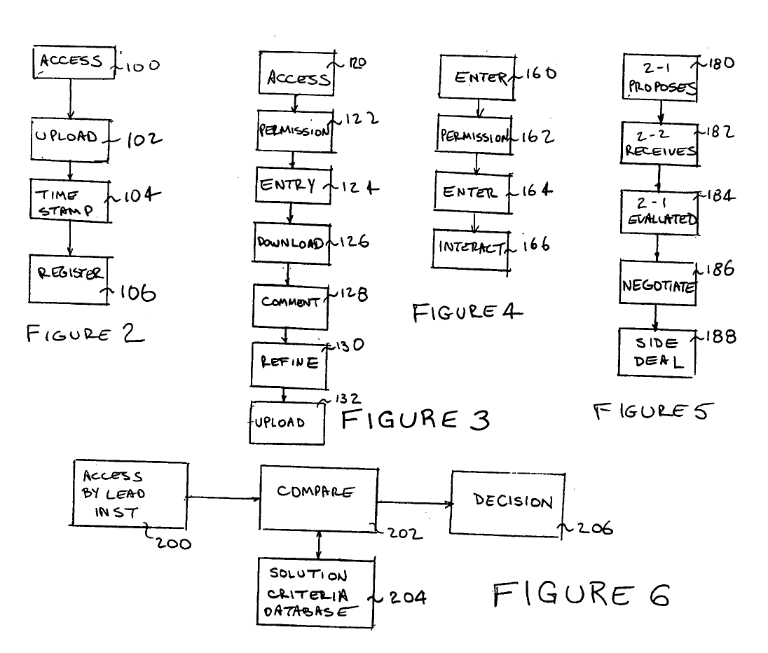

FIG. 3 illustrates a process for peer review of data. At block 120, a viewing member 2 accesses the network 10. At block 122, a permission routine evaluates access authorization on behalf of the particular member 2 according to a set of rules governing access to the research database 32 and entries of particular members 2 therein. At block 124, access is granted to authorized areas. At block 24, a menu, for example, may be presented of available areas. At block 126, the member 2 downloads requested information. The information may be viewed online or offline and at the same time or some future time. The viewing member 2 at block 128 may provide comments to the source member 2 or to others on an authorized list. At block 130, recipients may work to refine information subsequent to provision of comments at block 128. At block 132, revised information may be uploaded in accordance with the method of FIG. 2.

As seen in FIG. 4, a real-time forum may also be provided. Such a real-time forum allows directs contact between researchers and does not require administrative and budgetary approvals necessary for travel to conferences. At block 160, various members sign in. Access credentials are evaluated at block 162 and members enter a forum at block 164. Interaction occurs at block 166 in which online voice, video or other presentations may be made. The network 10 may also accommodate question and answer sessions.

FIG. 5 illustrates the generation of side deals between members 2. The members 2 may both comprise commercial companies or could comprise a university research department and a commercial company. The consortium 1 may seek to encourage formation of side deals to improve the interaction among members and increase the benefit to encouraging research. In one form of side deal, a commercial company may deal with a university. The company may provide laboratory services and equipment. The university may provide skilled labor such as faculty and graduate students. In FIG. 5, a first member, for example member 2-1 proposes an arrangement at block 180. At block 182, another member, for example, member 2-2 receives and evaluates the proposal. At block 184, the first member 2-1 evaluates feedback from member 2-2. Block 186 represents and interactive negotiation leading to a side deal at block 188. The side deal is stored at the side deal register 34 (FIG. 1).

FIG. 6 is an illustration of a process for identifying a “winning” research solution. A winning research solution is a solution that will earn income for the consortium 1. Selected solutions may be evaluated according a predetermined set of criteria to determine if they merit status as a winning solution. The benefit provided may be the result of “push” or “pull” technology. More specifically, push technology may be a very good scientific result which will push the community to find a beneficial manner in which to utilize the discovery. In the “pull” technology scenario, parties such as partners 18 state a need in the industry. Industry may mean actual commercial production, healthcare delivery or healthcare research, for example. A candidate solution is provided block 200. At block 202, the solution is compared to desired criteria from a solution criteria database 204. The solution criteria database 204 is included in the central computer 30 and contains solution criteria comprising an evaluation checklist. The evaluation checklist may embody specific parameters of a beneficial result that the consortium 1 has agreed is a “winning” solution. The consortium 1 may agree upon a number of different winning solutions, each of which may be stored in the solution criteria database 204. Proposed solutions are supplied by members 2 and are accessed by the administrator 5 or lead institution 7 at block 200. At a decision block 206, results of the comparison are evaluated. If a sufficient number of criteria are present to meet the definition of a winning solution, the decision block 206 recognizes that the “value” of the solution is at least a “winning” threshold level and provides a report thereof. A number of criteria sets may be stored in solution criteria database 204. The decision block 206 may provide a separate report for each solution stored in the solution database 204.

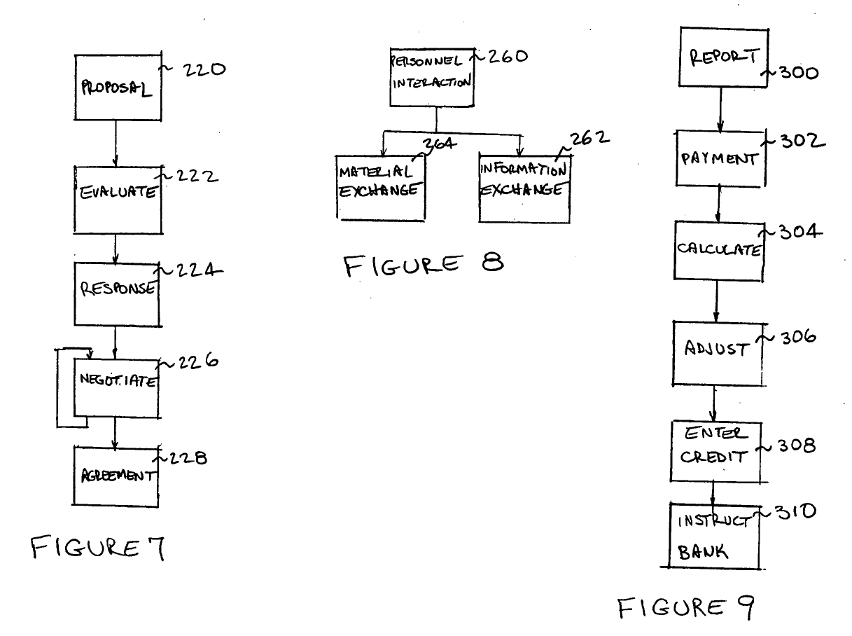

In FIG. 7, a negotiation with a negotiation entity 16 is defined. At block 220, a proposal is made by the consortium 1 to a negotiation entity 16. Alternatively, the negotiation entity 16 may request a set of terms from the consortium 1. At block 222, the entity 10 receiving the proposal evaluates the proposal with respect to its criteria and provides a response at block 224. At block 226, a further interchange may take place. A loop at an output of block 226 back to its input indicates that a negotiation could comprise several iterations. At block 228, an agreement is reached. At this point, the negotiation entity 16 becomes a partner 18. An agreement reached between the partner 18 and the consortium 1 is placed in the agreement register 40 (FIG. 1). The agreement includes rules governing interchanges between the partner 18 and the consortium. Interchanges may include further cooperative research. The interchanges may include provision of patient data. Interchanges may further include provision of materials from one entity to another.

Very significantly, the interchanges will include funding from the partner 18 to the consortium 1. The funding will customarily comprise a down payment plus a percentage of revenues received by the partner 18. Non-monetary interchanges are illustrated in FIG. 8 in which block 260 represents personnel interaction, block 262 represents information interchange and block 264 represents material interchange. The consortium 1 earns income based on the solution. “Earn” here comprehends all forms of gaining value. Earning may comprise collecting current cash, accruing income or receiving other forms of exchange recognized by a member 2 as having value. Income need not necessarily be recognized within the definition of the Internal Revenue Code.

FIG. 9 represents revenue flow. Customarily, the partner 18 will report to the consortium 1. Reports customarily comprise a report of revenue bearing activity for a specific time period such as a calendar quarter, calendar half or calendar year and remittance of a royalty fee. At block 300, the royalty is reported. At block 302, the royalty is paid by the partner 18. The payment of royalty may comprise electronic transmission by the partner 18 of funds to a financial institution 50 along with an electronic report via the interface 42 to the consortium 1. Fund reports are reported by the account generator 44 at block 304. The rule based account generator 44 has rules based on the agreement with the partner 18 stored in the agreement register 40. The rule based generator 44 may also receive an input from the side deal register 34 to make adjustments at block 306 as may be required in accordance with side deals that one member 2 may have with another member 2. The rule based generator 44 processes the revenues in accordance with the rules to credit the account of each member 2 in the account register 46 at block 308. Further, at block 310, the rule based account generator 44 may, via the interface 42 and the bus 12, instruct the financial institution 50 to make fund transfers to the account of the member 2. For simplicity in illustration, a connection is shown from the bus 12 to the account register 46 to illustrate that credits may be electronically received in the account register 46 for each member 2. However, this connection should also be viewed as illustrating at the financial institution may also provide payments directly to a financial institution designated by each member 2.

By providing a network in which peer to peer research interaction may take place rather than requiring communication up through one high archy of an institution and down through another, research interaction is enhanced. By providing a vehicle for authorized communication of proprietary work in a particular area, institutions, i.e., members 2 may get the fastest update on technological advances without having to wait nominal periods of time such as a year before research appears in refereed journals. Further, since access can be limited to co-venturers in a common effort to reach a given solution, disclosures may be more freely made due to the greatly reduced likelihood of occurrence of a public disclosure or occurrence of a commercialization event that would tend to damage the proprietary position of one or more members 2 or the entire consortium 1. The benefit of Metcalf's Law is provided in marshaling resources to meet a need. Members 2 may also take on the characteristics of a self-organizing system since each member 2 may do what it does best. Self-organizing systems commonly evolve into efficient organisms for meeting a need.

The above description has been written to enable those skilled in the art produce a system in accordance with the present invention while having the ability to make many departures from the particular embodiments disclosed.

1. A data processing system form of managing transactions in a research consortium comprising:
a membership register for identifying consortium members;
a research database to store entries by members and time-stamp means for identifying submission of research;
a means for resolving research substance into a set of characteristics;
a database means for storing a set of criteria;
said criteria being measured by presence or absence of a characteristic;
comparison means to determine if characteristics of a research solution meet a pre-defined set of criteria;
an interface for communication with a partner having an agreement with said consortium to compensate said consortium for use of said research solution;
a report register for receiving reports from said partner to receive reports defining compensatable uses of the research solution; and
a rule-based account generator for processing said report data, said rule-based account generator incorporating a rule defining share of each participant of compensation due to said consortium based on said report data, said rule-based account generator generating a result comprising an amount of compensation due to a participant in accordance with the rule.

2. A system according to claim 1 wherein said interface comprises means to receive transmissions indicative of electronic funds transfers to said consortium from said partner; and
wherein said rule-based generator comprises means for generating instructions to instruct a transfer to a participant in accordance with said result.

3. The system according to claim 1, further comprising a side deal register to store side deal arrangements between a participant and at least one other participant, said side deal register being coupled to said rule-based register to modify said rule in accordance with a side deal.

4. The system according to claim 1, comprising a lead institution terminal for operation by a lead institution, said CPU providing a privilege to said lead institution to characterize research submissions according to characteristics.

5. The system according to claim 1, further comprising a telecommunications routine for providing an on-line meeting of said participants.

6. The system according to claim 5, further comprising a privilege register for providing access to selected entries in said research database to selected populations.

7. The system according to claim 6, wherein selected populations comprise consortium members, the public, consortium negotiating partners and consortium partners.

8. The system according to claim 1, wherein said rule comprises Rw (100%−(N−1%))×I where Rw is a winner's share, N is the total number of participants in the consortium, and I is the amount of income accruing from the research solution and wherein Rp=I/(N−1), where Rp is a participant's share.

9. The system of claim 1, further comprising a membership register wherein members may vote to admit other members and wherein members may vote to remove members.

10. A system according to claim 9, wherein said membership register registers a result corresponding to an invitation for potential members receiving a vote of at least N−1 where N is the number of current members.

11. A system according to claim 9, wherein said membership register will register a result equivalent expulsion of a member in response to a vote of not less than N−1 where N is the total number of current members.

12. A method for creating and exploiting a research solution comprising: establishing a consortium consisting of a set of members, providing a network for communication among all members, authorizing access by members of the consortium to the network and protecting the network from non-members, communicating by at least a member to provide data to said network, exchanging data between at least one member and another member; tracking when and by whom each provision of data is contributed, identifying a solution in data in said network; earning income based on said solution; and allocating said income among said members in accordance with a predetermined rule.

13. The method of claim 12 further comprising providing a membership rule for adding new members and eliminating members and selectively adding or elimination members in accordance with the membership rule.

14. The method of claim 12 wherein allocating comprises calculating an amount due to a member utilizing the predetermined rule.

15. The method of claim 12 wherein said consortium is a medical research consortium and wherein said data inputs are proprietary to the consortium.

16. The method of claim 15 wherein one member in characterized as a winner based upon correspondence of input of the member with a solution and wherein the winner is allocated a winner's share in accordance with the rule.

17. The method of claim 16 wherein members other than the winner are characterized as participants and wherein each participant is allocated a participant's share in accordance with the rule.

18. The method of claim 17 wherein said rule comprises R=(100%−(N−1%))×I where Rw is a winner's share, N is the total number of members in the consortium, and I is the amount of income accruing from the research solution and wherein Rp=I/(N−1), where Rp is a participant's share.

19. The method of claim 18 wherein providing a network comprises providing a virtual private network.

20. The method of claim 19 further comprising distributing income to said members by means of electronic funds transfers; and
wherein said network comprises a rule-based generator programmed in accordance with said rule to generate instructions to instruct a transfer to a member.

21. The method of claim 20 further comprising maintaining a side deal register to store side deal arrangements between members and adjusting the calculation of said rule-based generator to modify said rule in accordance with a side deal.

22. The method of claim 21 further comprising conducting on-line meeting of said members on said network.

23. The method of claim 22 further comprising a providing access to selected entries in said network to selected populations.

24. The method of claim 23 wherein selected populations comprise consortium members, the public, negotiating entities and consortium partners.

25. A method according to claim 24 further adding or dropping a member in response to a vote of not less than N−1 where N is the total number of current members.
